(19) United States
(12) Patent Application Publication
(10) Pub. No.: US 2010/0100593 A1
(43) Pub. Date: Apr. 22, 2010

(54) METHOD AND SYSTEM FOR PROVIDING CONTENT SERVICE

(75) Inventors: Chia-Hung CHIEN, Tu-Cheng (TW); Chun-Wen WANG, Tu-Cheng (TW); Chih-Yuan CHUANG, Tu-Cheng (TW); Teng-Yu TSAI, Tu-Cheng (TW); Liang-Mao HUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/479,953

(22) Filed: Jun. 8, 2009

(30) Foreign Application Priority Data
Oct. 22, 2008 (CN) 200810305094.8

(51) Int. Cl. G06F 15/16; G06F 12/02

(52) U.S. Cl. 709/205; 711/103; 711/E12.008

(57) ABSTRACT

A system is used for providing content service to a plurality of clients through a wide area network. The system includes a central content server, a plurality of clusters and a connection management server. The central content server has a storage space for storing content. The content clusters are connected to a back-end network. The content clusters are located in the network between the central content server and the wide area network. The content clusters are capable of caching the content transmitted from the central content server, and sending the content to the clients. The connection management server is connected to the back-end network for managing a content connection between the content clusters and the wide area network.

### BACKGROUND

1. Technical Field

The invention generally relates to methods and/or systems related to provide content service requested by clients.

2. Description of Related Art

As there is an increasing number of users who are connected to the Internet and surf for various information, they meanwhile create tremendous demands for more content to be available and methods to deliver them over the Internet. Currently, the most commonly available information that is deliverable over the Internet includes text information, images and graphics, videos and audio clips.

Due to the technology improvement in the video compression, networking infrastructure, and the overall computer capability, the realization of Video on Demand (VOD) service is becoming feasible. During the recent years, the popularity of Internet World Wide Web accelerates the deployment of VOD service. Some VOD services have successfully delivered low quality audio/video over the Internet. Their services have been adopted by many aspects of multimedia applications including news on demand, distance learning, corporate training, and music distribution.

A conventional system for providing media content to clients includes a plurality of content streaming servers directly connecting to the Internet, and an authentication server for controlling the transmission between the content streaming servers and clients. This system has many disadvantages. Firstly, the content servers expose in the open environment which is not secured. Secondly, the content servers will be the bottle neck of the data transmission. Thirdly crash of any of the content servers will cause the whole system fail. Finally, the cost of the content servers is very high.

### BRIEF DESCRIPTION OF THE DRAWINGS

FIG. 1 is a schematic view of a system for providing content service.

FIG. 2 is a block view showing components of one content cluster.

FIG. 3 is a flow chart showing a method for providing content service.

### DETAILED DESCRIPTION

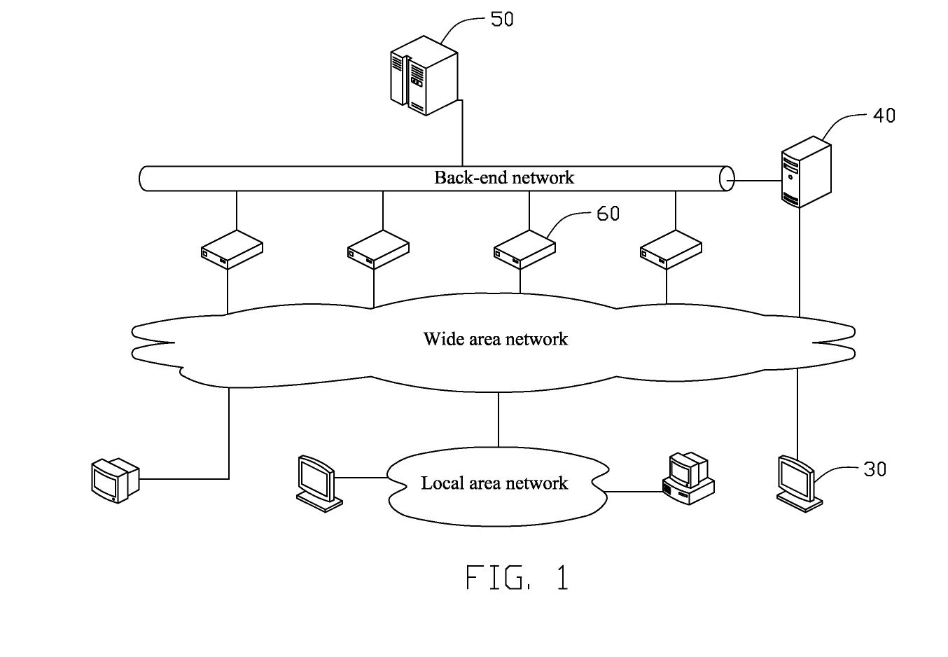

Referring to FIG. 1, a system is used for providing content service, such as multimedia streaming service, to a plurality of clients 30. The system includes a central content server 50, a plurality of content cluster 60 through a back-end network, and a connection management server 40 connected to the back-end network. The back-end network is constructed for internal content communication for providing content service. The central content server 50 has a storage space for storing a plurality of content.

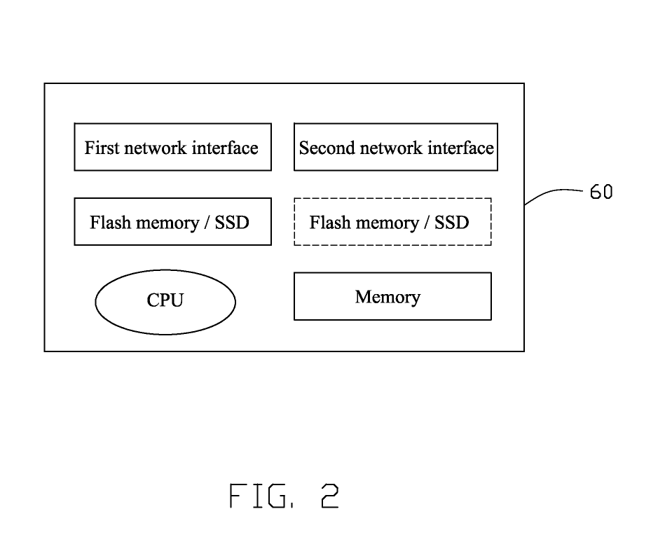

The content clusters 60 connect to the clients 30 via a wide area network, such that the content clusters 60 are located between the central content server 50 and the clients 30. The wide area network can be the Internet or an intranet. Referring to FIG. 2, in one embodiment, each content cluster 60 includes a central processing unit, a memory, two flash memories or two solid state disks (SSD), a first network interface and a second network interface. One of the flash memories is used for streaming the content to the client 30, and the other for buffering the content from the central content server 50. The first network interface is used for connecting to the Internet and the second network interface is used for connecting to the intranet. Each content cluster 60 is configured to a computer for providing caching service to the clients 30. The content clusters 60 are capable of caching the content transmitted from the central content server 50 and sending the content to the clients 30.

The connection management server 40 is capable of managing a content connection between the content clusters 60 and the clients 30. The connection management server 40 is capable of authorizing requests for content, and determining if requested content from a requesting client is stored in any of the content clusters 60. If the requested content is found in any of the content clusters 60, the connection management server 50 is capable of notifying the corresponding content cluster to send the requested content to the requesting client directly. If the requested content is not found in any of the content clusters 60, the connection management server 40 may instruct the central content server 50 to load the requested content to a designated content cluster or a free content cluster. In detail, the designated content cluster may have shortest network transmission path relative to the requesting client, or the designated content cluster and the requesting client are connected to the Internet by a same Internet service provider (ISP).

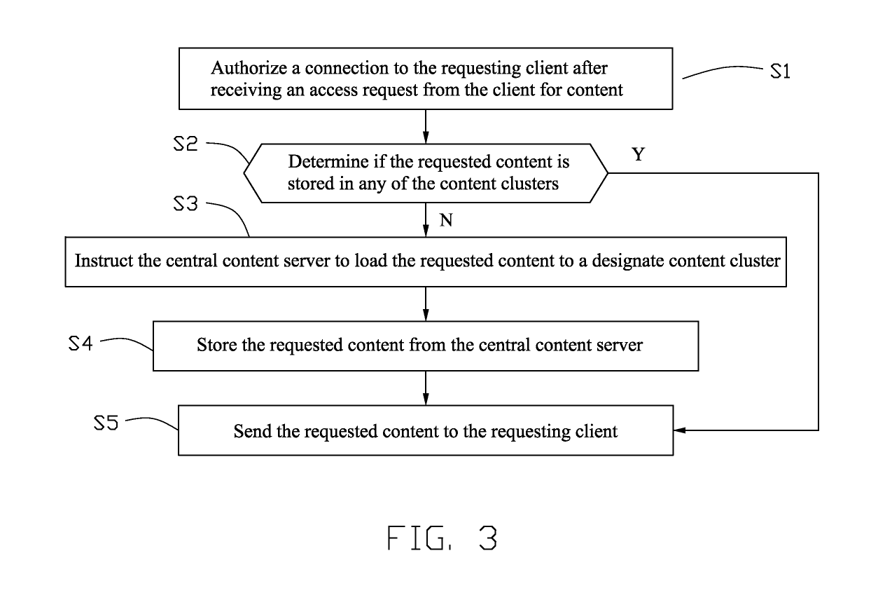

Referring to FIG. 3, a method for providing content service to a client includes the following steps:

S1: the connection management server 40 authorizes a connection to the requesting client after receiving an access request from the client for content;

S2: the connection management server 40 determines if the requested content is stored in any of the content clusters 60, if the requested content is not found in any of the content clusters 60, go to S3, if the requested content is found, jump to S5;

S3: the connection management server 40 instructs the central content server 50 to load the requested content to a designate content cluster or a free content cluster, wherein the designate content cluster may have shortest network transmission path relative to the requesting client, or the designated content cluster and the requesting client may be connected to the Internet by a same Internet service provider;

S4: the corresponding content cluster stores the requested content from the central content server 50 through a back-end network; and

S5: the corresponding content cluster sends the requested media content to the requesting client through a wide area network, wherein this step can further include streaming the requested content to the requesting client through the wide area network.

The system and method for providing content service have the following advantages. The content clusters are much cheaper than the content server, and usage of the content clusters can reduce usage of the content server. The content clusters can facilitate processing same content requests without frequently reading the central content server. Damage of one content cluster may not affect the rest of the system, adding to reliability. The content server does is not directly exposed to the clients, so the system is more secure.

It is also to be understood that the above description and the claims drawn to a method may include some indication in reference to certain steps. However, the indication used is only to be viewed for identification purposes and not as a suggestion as to an order for the steps.

What is claimed is:

1. A system for providing content service to a plurality of clients through a wide area network, the system comprising:
a central content server having a storage space for storing content;
a plurality of content clusters connected to the central content server via a back-end network and connected to the wide area network, such that the content clusters located between the central content server and the wide area network, wherein the content clusters are capable of caching the content transmitted from the central content server, and sending the content to the clients; and
a connection management server connected to the back-end network for managing a connection between the content clusters and the wide area network.

2. The system of claim 1, wherein the connection management server is capable of determining if a requested content is stored in any of the content clusters.

3. The system of claim 2, wherein if the requested content is not found in any of the content clusters, the connection management server is capable of notifying the central content server to load the requested content to at least one of the content clusters.

4. The system of claim 2, wherein the connection management server is capable of notifying the central content server to load the requested content to a designated content cluster.

5. The system of claim 4, wherein the designated content cluster has shortest network transmission path relative to the requesting client.

6. The system of claim 4, wherein the designated content cluster is connected to an Internet service provider, and the Internet service provider is the same as the client's Internet service provider.

7. The system of claim 3, wherein the connection management server is capable of notifying the central content server to load the requested content to a free content cluster.

8. The system of claim 2, wherein if the requested content is found in any of the content clusters, the connection management server is capable of notifying the corresponding content cluster to send the requested content to the client directly.

9. The system of claim 1, wherein the connection management server is capable of authorizing request for content.

10. The system of claim 1, wherein each content cluster comprises a first network interface for connecting to the wide area network and a second network interface for connecting to an Intranet.

11. The system of claim 1, wherein each content cluster comprises two flash memories, one for streaming the content to the requesting client, and the other for buffering the content from the central content server.

12. A method for providing content service to a requesting client, the method comprising:
providing one or more content clusters;
receiving a request for requested content;
determining if the requested content is stored on one of the one or more content clusters;
on the condition that the requested content is not on one of the one or more content clusters, a central content server is notified to load the requested content to one of the one or more content clusters, and the content cluster receives the requested content from the central content server and sends the requested content from the content cluster through a wide area network.

13. The method of the claim 12, wherein the steps of receiving a request, determining the requested content and notifying a central content server are executed by a connection management server.

14. The method of the claim 13 further comprising authorizing an access connection to the requesting client by a connection management server.

15. The method of the claim 12, wherein each content cluster comprises a first network interface for connecting to the wide area network and a second network interface for connecting to an intranet.

16. The method of the claim 12, wherein each content cluster comprises two flash memories, one for streaming the content, and the other for buffering the content from the central content server.

17. The method of claim 12, wherein notifying a central content server to load the requested content further comprises instructing the central content server to load the requested content to a designated content cluster which has shortest network transmission path relative to the requesting client.

18. The method of claim 12, wherein notifying a central content server to load the requested content further comprises instructing a central content server to load the requested content to a designated content cluster, and the designated content cluster and the requesting client are connected to the wide area network by a same Internet service provider.
